(19) United States
(12) Patent Application Publication
(10) Pub. No.: US 2013/0234523 A1
(43) Pub. Date: Sep. 12, 2013

(54) METHOD AND APPARATUS PROVIDING POINT OF INTERCONNECTION CONTROL FOR POWER PLANTS

(71) Applicants: Dmitriy Anichkov, Somerville, NJ (US); Mahesh Morjaria, Mesa, AZ (US)

(72) Inventors: Dmitriy Anichkov, Somerville, NJ (US); Mahesh Morjaria, Mesa, AZ (US)

(73) Assignee: FIRST SOLAR, INC, Perrysburg, OH (US)

(21) Appl. No.: 13/413,507

(22) Filed: Mar. 6, 2012

(51) Int. Cl. H02J 1/00

(52) U.S. Cl. 307/82

(57) ABSTRACT

A method and apparatus to control power output of a power plant. A control module includes a plurality of controllers for different power parameters of the power plant and a master controller. The plurality of controllers receive measured parameters from the power plant, compare the received parameters with received set points, and provide respective reactive power commands to the power plant. The master controller determines which of the plurality of controllers is to be enabled to output a reactive power command to the power plant.

### FIELD OF THE INVENTION

The disclosed embodiments relate to control systems for power plants, and methods of using the same.

### BACKGROUND OF THE INVENTION

Energy can be derived from many different sources, including, but not limited to, photovoltaic (“PV”) devices, wind turbines and geothermal sources. Derived energy can be collected from power plants, conditioned and then coupled to an electrical network such as a utility grid. An example of a power plant is a photovoltaic (PV) power plant containing an array of electrovoltaic devices, such as photovoltaic modules and associated interconnected electrical wires and devices such as inverters.

PV devices can be networked together to form a power plant such as a PV power plant. A large PV power plant may include hundreds of thousands of square feet of PV devices covering many acres. The PV devices are dispersed so as to maximize the power plant's energy-collecting capability. Energy collected by each PV device is generally pooled to one or more power converters through a number of collector cables or buses. The power converters typically include DC/AC inverters which convert direct current to alternating current for use on a coupled utility grid. The utility grid is coupled to the PV power plant via one or more power lines. The point at which the PV power plant is connected to a utility grid is referred to as a point of interconnection, or POI. Transmission lines or buses are on the utility grid side of the POI while collector lines or buses are on the PV power plant side of the POI.

Because the utility grid requires that supply and demand of provided electricity be carefully balanced, there is a need for a robust control of PV power plant output into the utility grid. When demand is high from the utility grid, the PV power plant may be required to increase its active power output capacity to the available generation capacity. At times of low demand, the PV power plant active power output capacity may be required to decrease. Control for the necessary increase or decrease in active power output may be facilitated by a POI control module.

Unlike some traditional power plants (e.g., coal, nuclear) where electricity generation at the power plant is generally constant over an extended period of time, a PV power plant is subject to significant variations in electricity output levels due to frequent disturbances in the solar resource. A passing cloud, for example, can temporarily reduce the generating power of the PV power plant by a significant amount. The POI control module is used to ensure that the active power output delivered to the utility grid does not exceed an operator provided limit when required. To the extent compensation for the fluctuations in power generation is possible, such compensation is preferably also under the control of the POI control module.

Therefore, the POI control module plays a vital role in a PV power plant's ability to limit active power output that meets the demands of the coupled utility grid. In addition, the POI control module also regulates voltage, power factor, or reactive power at the POI to meet the demand of the grid. The POI control module achieves this by manipulating reactive power production of the plant and controlling capacitors and inductors if the plant is equipped with them.

However, there may be conflicting requirements for power control for the POI control module which can be difficult to manage. For example, the voltage control must be managed within the limits of the reactive power capability of the PV plant. If the grid voltage is too high or too low, the reactive power provided by the plant will reach its limit. In addition, the POI control module must ensure that the voltage levels within the plant (e.g., at an inverter terminal) do not exceed their allowable limits. Also, the POI control module must manage the tradeoff between active and reactive power production if required. Accordingly, a POI control module which manages a PV power plant output (both active and reactive), while handling sometimes conflicting control requirements, is needed.

### BRIEF DESCRIPTION OF THE DRAWINGS

FIG. 1 illustrates an embodiment of a power plant control system.

FIG. 2 illustrates an embodiment of a point-of-interconnection control module.

FIG. 3A illustrates an embodiment of a voltage controller.

FIG. 3B illustrates an embodiment of a voltage droop profile used by an embodiment of a control module.

FIG. 4 illustrates an embodiment of a reactive power controller.

FIG. 5 illustrates an embodiment of a power factor controller.

FIG. 6 illustrates an embodiment of a method of switching controllers in a power plant control system.

FIG. 7 illustrates an embodiment of a point-of-interconnection control module at a power plant.

FIG. 8 illustrates an embodiment of a method of adding and removing static devices in a power plant control system.

### DETAILED DESCRIPTION OF THE INVENTION

In the following detailed description, reference is made to the accompanying drawings, which form a part hereof, and in which is shown by way of illustration specific embodiments that may be practiced. It should be understood that like reference numbers represent like elements throughout the drawings. Embodiments are described with sufficient detail to enable those skilled in the art to practice them. It is to be understood that other embodiments may be employed, and that various structural, logical, and electrical changes may be made without departing from the spirit or scope of the invention.

Disclosed herein is an apparatus providing an improved POI control module for a PV power plant and methods of using the same. The POI control module (“PCM”) is configured to manage the handling of all POI conditions that may be imposed, for example, by the connected utility grid. To do this, and as further explained below, the PCM is configured to provide automatic voltage regulation, reactive power regulation and power factor regulation as well as limiting active power when required. In addition, if the PV power plant includes capacitor banks or inductor banks for reactive power support, the PCM is configured to manage these static devices in order to add or take away reactive power generating capacity, if necessary, to augment the required reactive power. The PCM interfaces with a PV plant control module in order to coordinate control of the various components of the PV power plant.

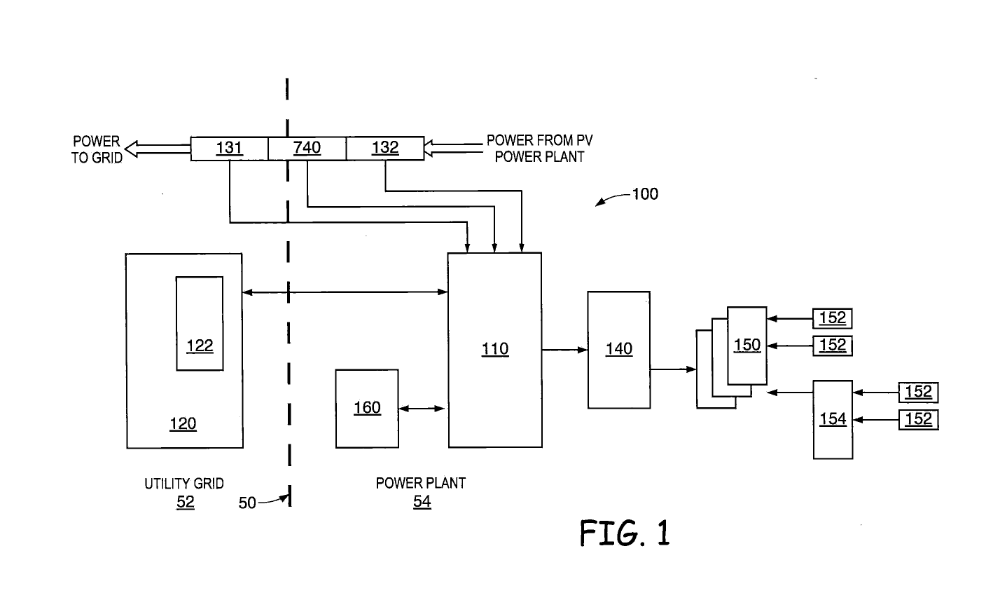

The basic functions of the PCM are described below with reference to a control system 100 illustrated in FIG. 1. The control system 100 in FIG. 1 illustrates control interconnections made between various control components located both at and away from a PV power plant. In control system 100, a PCM 110 is located at or near a POI 50 between a utility grid 52 and a PV power plant 54. PCM 110 receives various set points from, for example, an energy management system (“EMS”) 122. The set points can include specific output requirements for the PV power plant 54, such as commands for specific power output, and/or voltage level, or power factor set point. Alternatively, the set points can be provided to the PCM 110 via a power plant side local supervisory control module 160 such as a local supervisory control and data acquisition (“SCADA”) system with a human-machine interface (“HMI”). As explained below, the local supervisory control module 160 can be used to override the set points received from the EMS 122.

The PCM 110 also receives information regarding the up-to-date voltage and current levels associated with the POI 50 and other areas of the power plant. The voltage and current levels may be measured, for example, from several locations including potential transformers and current transformers located at either transmission buses 131 on the utility grid 52 side, at collector buses 132 on the power plant 51 side, or at an interconnecting circuit breaker 740 located at the POI 50. Transmission buses 131 deliver power to the utility grid 52 from the POI 50. Collector buses 132 deliver power from the PV power plant 54 to the POI 50. In addition to voltage and current, other parameters may be measured from the buses 131, 132 or circuit breaker 740, such as AC frequency and amounts of active and reactive power delivered to the transmission buses 131, or the collector buses 132 or passing through circuit breaker 740.

The PCM 110 uses the set point inputs from the EMS 120 or the local supervisory control module 160 and also receives the present-value voltage and other parameter measurements from the POI buses 131, 132 or circuit breaker 740 to determine the output requested of the PV power plant 54. Once determined, the PCM 110 sends an output command to a PV plant control module 140, which functions to enforce the received command by regulating the output of a plurality of inverters 150 which are connected to the PV devices 152 in the PV power plant 54. Each inverter 150 may connect with a plurality of individual PV devices 152. Inverters 150 may connect directly with the plurality of individual PV devices 152, or may alternatively connect via one or more DC/DC collectors 154. The PV plant control module 140 can regulate both the output of the plurality of inverters 150 and the one or more DC/DC converters 154.

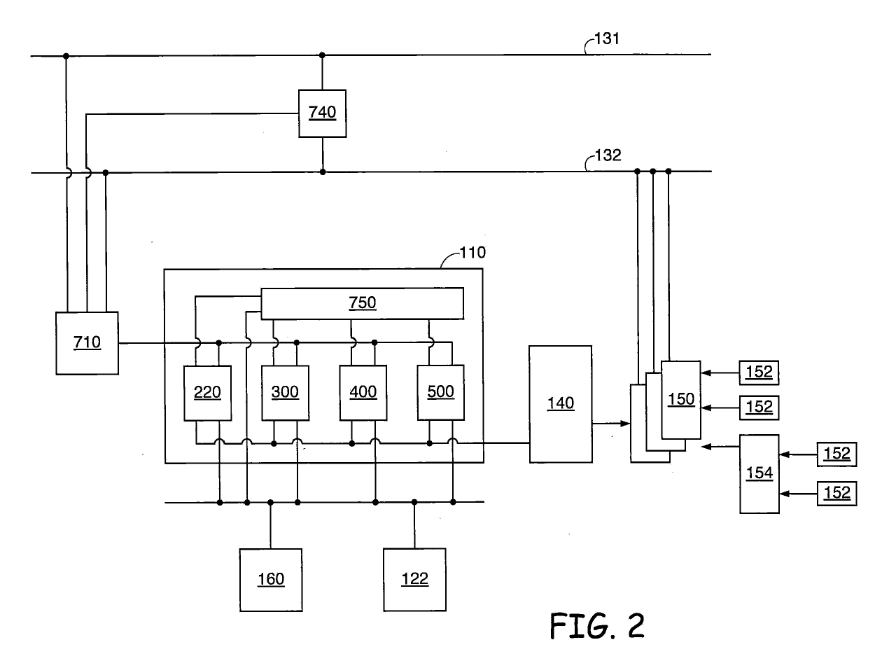

In another representation, FIG. 2 illustrates the PCM 110 and the entities to which the PCM 110 interconnects. Unlike FIG. 1, which primarily illustrates control interconnections between components of the POI control system 100, FIG. 2 illustrates both control and power interconnections in greater detail. In FIG. 2, the PCM 110 is coupled to at least one measuring device 710, which in turn is coupled to transmission buses 131, collector buses 132 and the circuit breaker 740. The PCM 110 is also coupled to a PV plant control module 140. Additionally, the PCM 110 is in communication with either the PV plant's local supervisory control module 160 such as a SCADA system, or an external power substation with an energy management system or EMS 122. The power interconnections in FIG. 2 are represented by the transmission buses 131, which are coupled to the collector buses 132 via the circuit breaker 740. The collector buses 132 receive power from the inverters 150.

The inverters 150 are each connected to a plurality of arrays of PV devices 152, often via one or more DC/DC converters 154. Energy collected at each PV device array 152 is directed and channeled through a series of cables to the one or more converters 154 and inverters 150. At the DC/DC converters 154, the generated power is collected into higher-voltage cables. At the inverters 150, the generated power is boosted or decreased and regulated so as to be at a stable known amount of power. A PV power plant may include a hierarchy of converters 154 and inverters 150, with higher-level DC/DC converters outputting higher voltages than lower-level DC/DC converters. At the highest level of the hierarchy are one or more central power converters that are generally in the form of DC/AC inverters 150. These central power converters convert the direct current delivered by the lower-level converters 154 to alternating current for use on the coupled utility grid 52. Because each converter 154 and inverter 150 in the PV power plant can be controlled to boost or decrease the output power, the power output of the PV power plant is determined by the control signals received by the converters 154 and inverters 150 (collectively, power regulators). In FIG. 2, the converters 154 and inverters 150 represent all of the power regulators in a PV power plant that can receive a control signal.

FIG. 2 also illustrates additional detail with respect to the PCM 110. In FIG. 2, the PCM 110 includes a master control module 750 and a plurality of controllers 220, 300, 400 and 500. As is explained in greater detail below, the master control module 750 functions to enable one of the controllers 300, 400 and 500 to output a command to the PV plant control module 140. Controller 220 within PCM 110 also outputs a command to the PV plant control module 140, but is continually enabled, whereas only one of controller 300, 400 and 500 is enabled at any given moment. Commands are output by the controllers 220, 300, 400 and 500 at the direction of the master control module 750 and in response to inputs received by each controller. Controllers 220, 300, 400 and 500 receive as inputs measurements from the at least one measuring device 710. Controllers 220, 300, 400 and 500 and master control module 750 also receive as inputs set points received via local control from the PV power plant's SCADA system 160 or via remote control from a utility grid's EMS 122. For example, when responding to remote control, the controllers 220, 300, 400 and 500 in the PCM 110 respond to external set points issued from an EMS 122. The EMS 122 is used by a utility grid 52 (or the generation company) to determine the energy needs of the grid. Those needs are then translated to set points that are sent from the EMS 122 to the controllers 220, 300, 400 and 500 and the master control module 750 in PCM 110. The PCM 110 also relays the received set points via, for example, the master control module 750, to the local PV power plant SCADA system 160 so that the PV power plant can monitor both the set points received by the PCM 110 and the response of the PV power plant.

When the PCM 110 is responding to local control by the PV power plant's SCADA system 160, an operator at or remotely operating through the SCADA system 160 switches the PCM 110 from external control to local control. Local control allows a local PV power plant operator to override external set points from EMS 122, ensuring that demands made of the PV power plant are consistent with the PV power plant's goals and safe operating criteria. The PCM 110 operates under local control until an operator at or remotely operating through the PV power plant's SCADA system 160 switches the control back to EMS 122. Control can also be switched automatically in response to pre-defined conditions.

The controllers 220, 300, 400 and 500 in PCM 110 receive measured parameters from measuring device 710 as inputs. The measured parameters received by a controller may include voltage measurements, reactive power measurements, power factor measurements as well as active power measurements. The controllers 220, 300, 400 and 500 use the received parameters to determine commands to output to the PV plant control module 140. At any given moment, controller 220 is active but only one of controllers 300, 400 and 500 is enabled to output a command, as dictated by the master control module 750.

Controller 220 in PCM 110 is an active power limit controller. The active power limit controller 220 outputs a command to limit the amount of active power produced by the PV power plant. The active power limit controller's output is in response to an input maximum active power set point set by the PV power plant's SCADA system 160, for example. Thus, using the active power limit controller 220, the PCM 110 is enabled to receive a maximum active power set point and output to the PV plant control module 140 an active power command that will result in limiting the active power output from the PV power plant to no more than the input maximum active power set point.

In addition to commands output by the active power limit controller 220, commands are also output by one of controllers 300, 400 and 500. Although the controllers 300, 400 and 500 respond to various set points and parameters, each controller outputs similar types of commands. That is, each controller outputs a command for a desired amount of reactive power from PV power plant 54. For example, and as explained in greater detail below, controller 300 is a voltage controller. Voltage controller 300 receives a set point requiring a specific voltage at either a transmission bus 131, a collector bus 132 or a circuit breaker 740. The voltage controller 300 also receives a measured parameter indicating to the controller 300 the voltage at the transmission bus 131, collector bus 132 or circuit breaker 740. The voltage controller 300 uses this information to output a command to the PV plant control module 140 for a required amount of reactive power to be output from the PV power plant. The required amount of reactive power will result in the desired voltage at the measured transmission bus 131, collector bus 132 or circuit breaker 740. Thus, controllers 300, 400 and 500 may be required to compute a necessary amount of reactive power based on the received set point.

Thus, using the voltage controller 300, the PCM 110 is enabled to receive a voltage set point and output to the PV plant control module 140 a reactive power command that will result in a corresponding reactive power output from the PV power plant which will achieve the input voltage set point as long as the active power limit monitored by controller 220 is not exceeded. The reactive power output from the PV power plant results in a stable voltage at the POI that is at or within a predefined range of the required voltage set point.

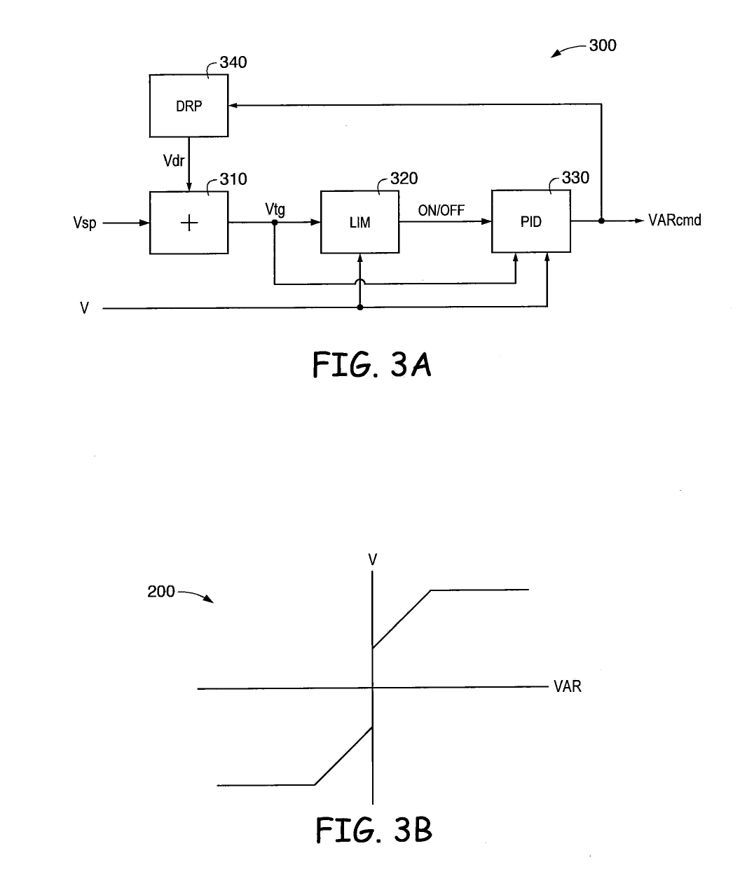

FIG. 3A illustrates the voltage controller 300. The voltage controller 300 receives as input a voltage set point Vsp. The voltage set point Vsp is summed by summer 310 with a droop voltage signal Vdr from droop voltage source 340. The droop voltage signal Vdr is provided in order to enable the PV power plant output to be more stable. In essence, the PV power plant has additional resistance built-in to the plant that is used to compensate for sudden changes in the PV power plant's load. In an uncompensated circuit, a sudden change in load will cause the output voltage to temporarily droop or sag. A circuit that is compensated with additional resistance is less susceptible to voltage droop. However, this means that the voltage to be output by the inverters of the PV power plant is actually different than the received set point voltage. Thus, in voltage controller 300, a droop voltage signal Vdr provided by droop voltage source 340 is added to the voltage set point Vsp at summer 310 in order to derive a target voltage Vtg.

At comparator 320, the target voltage Vtg is compared with the voltage V measured at a bus at the POI. If the measured voltage V is within a predefined range or limit LIM of the target voltage Vtg, then the comparator 320 outputs an OFF signal to PID controller 330, and the voltage controller 300 does not output a command. In other words, because the measured voltage V and the target voltage Vtg are close to each other, no change in output from the PV power plant is necessary. However, if comparator 320 determines that the measured voltage V is not within a predefined range or limit LIM of the target voltage Vtg, then the comparator 320 outputs an ON signal to PID controller 330, ultimately resulting in the PID controller 330 outputting a reactive power command VARcmd to plant control module 140.

PID controller 330 includes a proportional, integral and derivative (“PID”) control loop, as is known in the art. PID controller 330 accepts as inputs the target voltage Vtg and the measured voltage V. Modeling a closed loop feedback system, the PID controller 330 outputs a VARcmd command to the plant control module 140 in order to control the PV power plant inverters and/or converters to provide an output which will produce a reactive power voltage within the limit specified by comparator 320. This means that, in addition to providing a closed loop feedback system, PID box 330 also converts the received voltages into a desired reactive power.

The output reactive power command VARcmd is output from the voltage controller 300 and may be output to the PV plant control module 140 of FIGS. 1 and 2, under the direction of the master control module 750. The reactive power command VARcmd is also returned as feedback to a droop voltage source 340 in controller 300 to provide an appropriate droop voltage Vdr to be summed with the received voltage set point Vsp.

The droop voltage Vdr is generated by the source 340 in accordance with a droop voltage profile 200, illustrated in FIG. 3B. In the profile 200, a voltage droop relationship between voltage V (on the y-axis) and reactive power VAR (on the x-axis) is shown. For a known reactive power VAR, the profile 200 shows the corresponding voltage V that compensates for possible voltage droop. In the profile 200, a reactive power VAR with a high magnitude is capped at a droop voltage V so as to ensure that voltages in the PV power plant are not driven beyond rated limits. The droop voltage profile 200 is an example of a possible droop voltage profile; other profiles may be used depending on the design of the PV power plant.

The power command VARcmd, which is a request or command sent to the PV plant control module 140 to change the amount of reactive power being generated. The reactive power command VARcmd indicates the amount of reactive power that is required. The reactive power command VARcmd is communicated to the PV plant control module 140 so that the required amount of reactive power is output from the inverters 150. Thus, the reactive power command VARcmd results in an update to the output voltage V at the POI that is within a predefined limit LIM of the voltage set point Vsp.

The PCM 110 also includes a reactive power controller 400. As with the voltage controller 300, the reactive power controller 400 is responsive to a received set point by determining a necessary reactive power output from the PV power plant. The received set point is a reactive power set point, and the reactive power controller 400 outputs a command to the PV plant control module 140 that results in a stable reactive power at the POI that is at or near the required reactive power set point.

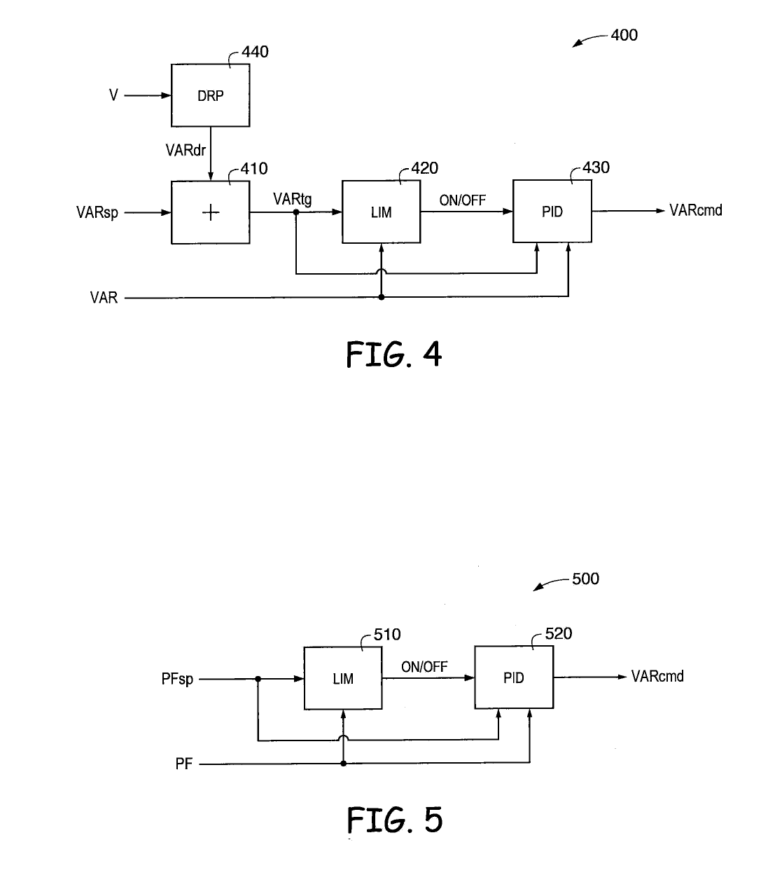

The reactive power controller 400 is illustrated in FIG. 4. The reactive power controller 400 receives as an input a reactive power set point VARsp. The reactive power set point VARsp is received either locally from the PV power plant's SCADA system or from an external EMS 122 at, for example, power substation 120. At summer 410, the reactive power set point VARsp is summed with a reactive power droop signal VARdr. As with the voltage controller 300, a droop signal from droop signal source 440 is added to the set point signal in order to compensate for any expected voltage droop that could occur as a result of changes in PV power plant load. In reactive power controller 400, the reactive power droop signal VARdr is determined using the droop voltage profile 200 of FIG. 3B. The voltage V at a transmission bus 131, collector bus 132 or circuit breaker 740 at the POI is input to droop signal source 440, and, in accordance with the droop profile 200, box 440 outputs a reactive power droop signal VARdr.

At summer 410, the reactive power set point VARsp and the reactive power droop signal VARdr are summed to yield a reactive power target signal VARtg. At comparator 420, the reactive power target signal VARtg is compared with the PV power plant's output reactive power VAR, as measured at the transmission bus 131, collector bus 132 or circuit breaker 740 at the POI. If the measured reactive power VAR is within a predefined range or limit LIM of the reactive power target signal VARtg, an OFF signal is output to the PID controller 430, and the controller 400 outputs no command. If, however, the measured reactive power VAR differs from the reactive power target signal VARtg by more than the predefined range or limit LIM, then the comparator 420 outputs an ON signal to the PID controller 430.

The PID controller 430 accepts as inputs the measured reactive power VAR and the reactive power target signal VARtg and applies them to a PID closed loop feedback system to output a reactive power command VARcmd. The reactive power command VARcmd indicates the total amount of reactive power that is required from the PV power plant to obtain the reactive power set point VARsp within the limit LIM set by comparator 420. The reactive power command VARcmd is communicated to the PV plant control module 140 so that the PV plant control module 140 can order the determined amount of reactive power from the inverters 150 and/or converters 154.

FIG. 5 illustrates the power factor controller 500, located within PCM 110. As with the other controllers, the power factor controller 500 is responsive to a received power factor set point and determines a necessary reactive power output command VARcmd from the PV power plant. The output command VARcmd results in a stable power factor at the POI that is at or near the required power factor set point. Power factor, or PF, is a ratio between active power and apparent power. In an electric power system, a system with a low power factor draws more current than a system with a high power factor for the same amount of useful power transferred. The higher currents increase the energy lost in the distribution system, and require larger wires and other equipment. Because of the costs of larger equipment and wasted energy, electrical utilities will often charge a higher cost to industrial or commercial customers where there is a low power factor. Thus, both utilities and the PV power plant may have a motivation to set a power factor set point.

The power factor controller 500 receives as input a power factor set point PFsp, which is set locally from the PV power plant's SCADA system 160 or remotely from an external EMS 122 at, for example, power substation 120. At comparator 510, the received power factor set point PFsp is compared with the PV power plant's output power factor PF, as determined through measurements at either a transmission bus 131, a collector bus 132 or a circuit breaker 740 at the POI. If the measured power factor PF is within a predefined range or limit LIM of the power factor set point PFsp, the comparator 510 outputs an OFF command to the PID controller 520, and no command is output by the power factor controller 500. If, however, the measured power factor PF is not within the predefined range or limit LIM of the power factor set point PFsp, the comparator 510 outputs an ON command to the PID controller 520. The PID controller 520 uses the measured power factor PF and the power factor set point PFsp as inputs and applies a closed loop feedback system to determine an output command VARcmd. The PID controller 520 converts the power factor inputs into a reactive power command output VARcmd. The reactive power command VARcmd indicates the total amount of reactive power that is required from the PV power plant in order to maintain the required power factor at the POI. The reactive power command VARcmd is communicated to the PV plant control module 140 so that the PV plant control module 140 can order the determined amount of reactive power from the inverters 150 and/or the converters 152.

The plurality of active power limit controllers 220, voltage controllers 300, the reactive power controllers 400 and the power factor controllers 500 are implemented by the PCM 110. The PCM 110 may include various numbers of each controller in order to correspond to the numbers of transmission and collector buses, as well as for circuit breaker 740.

The different controllers in the PCM 110 each have distinctly different goals (e.g., meeting a voltage set point, meeting a reactive power set point, or meeting a power factor set point). The different goals of each controller can potentially result in contradictory commands arising from the PCM 110 if each of controllers 300, 400 and 500 were to operate simultaneously and independent of each other. For example, the voltage controller 300, which is designed to maintain a specific voltage on a transmission bus, can potentially output a reactive power command VARcmd that results in a large amount of reactive power generation by inverters connected to a collector bus, thus resulting in a collector bus overvoltage condition. If a separate voltage controller 300 was maintaining a voltage on the collector bus 132, the two voltage controllers could be in conflict with each other. As another example, a reactive power controller 400 maintaining a specific reactive power on a transmission bus 131 could result in the transmission bus power factor shifting beyond a specified control range. Thus, in this example, the reactive power controller 400 for the transmission bus could be in conflict with a power factor controller 500 for the same transmission bus.

Therefore, in order to avoid such conflict, the PCM 110 includes the master control module 750 that coordinates the actions of the controllers 300, 400 and 500. The master control module 750 may include software or hardware and may be a combination thereof The master control module 750 outputs overriding control signals to the controllers 300, 400 and 500 to enable or disable the controllers. Under the master control module 750, the operations of each of the PCM's controllers 300, 400 and 500 are coordinated so that only one controller is active at any given time and is able to output a reactive power command VARcmd. The active controller 300, 400, 500 is selected by an operator providing an input to master control module 750 using either remote or local control. Alternatively, the active controller is selected by the PCM 110 in accordance with priorities established by an operator or that are predefined. The active one of controllers 300, 400, 500 remains active, while the other controllers 300, 400, 500 each monitor respective parameters. However, if a controller identifies that its monitored parameter is approaching an upper or lower limit or is shifting from a corresponding set point by more than a predetermined limit LIM, the controller sends a signal to the master control module 750 and then the master control module 750 may require that the active controller become inactive and that the controller that identified the shifting parameter becomes the new active controller. Once the parameters being monitored by the new active controller are returned to within an allowable range of the monitored set point, the master control module 750 may return control to the previous active controller.

In order to justify switching controllers, a controller's parameter must either exceed a set threshold or shift beyond a predefined range LIM bounding the controller's respective set point. The predefined ranges or thresholds are stored and used by comparators 320, 420 and 510 in controllers 300, 400 and 500, respectively. Multiple limits or alarms may be configured for any given controller, if desired.

Time limits or deadbands can also be set that prevent frequent controller switching, if desired. For example, a minimum time limit can be set that prevents controllers from switching too quickly after a previous switch. Additionally, a range of values may be set for each controller such that a variation of the controller's monitored parameters within the deadband or range will not result in controller switching. Time limits or deadbands can be configured and individually enabled or disabled by an operator and are stored in comparators 320, 420 and 510.

There may be circumstances when multiple set points are received that cannot all be satisfied simultaneously. For example, it is possible that the PCM 110 could receive a power factor set point and a voltage set point that cannot both be satisfied at the same time. In such a case, the set point with a highest priority is satisfied. The lower priority set point remains unsatisfied as long as the conflicting set points exist. Priorities are programmed into the master control module 750 and may be updated by an operator. Priorities may reflect efforts to maintain the safety and integrity of the PV power plant and/or may reflect contractual agreements between the PV power plant and coupled utility grids.

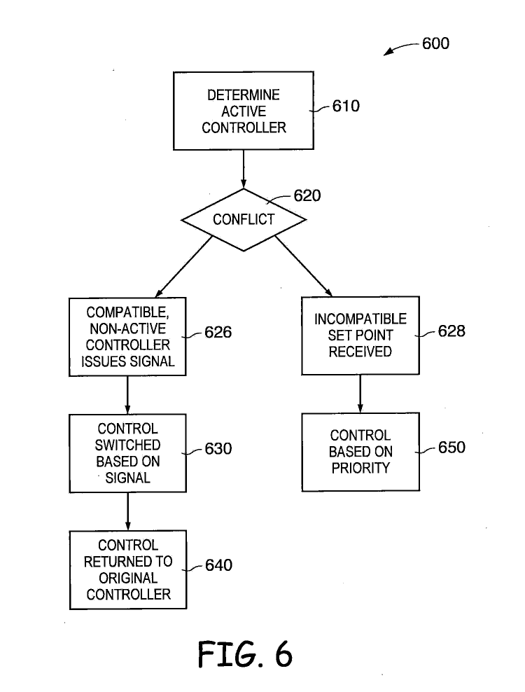

FIG. 6 illustrates a conflict resolution method 600 applied by the master control module 750. At step 610, the master control module determines an active controller. The determination is made based upon received set points and operator priorities. At step 620, a conflict is identified. The conflict could be that a parameter being monitored by a non-active controller has triggered an alarm because the parameter is shifting away from its set point (step 626). The conflict could also be that a set point has been received that is incompatible with, but does not replace, an existing set point (step 628). If the competing set points are potentially compatible, the master control module switches control to the controller that triggered the alarm (step 630). The newly activated controller remains active until its monitored parameter is returned to its set point, and then the master control module switches control back to the previously determined active controller (step 640). If, at step 620, the competing set points are not compatible, the master control module switches control to the controller with the highest priority, as defined by an operator or according to a predefined priority ranking (step 650).

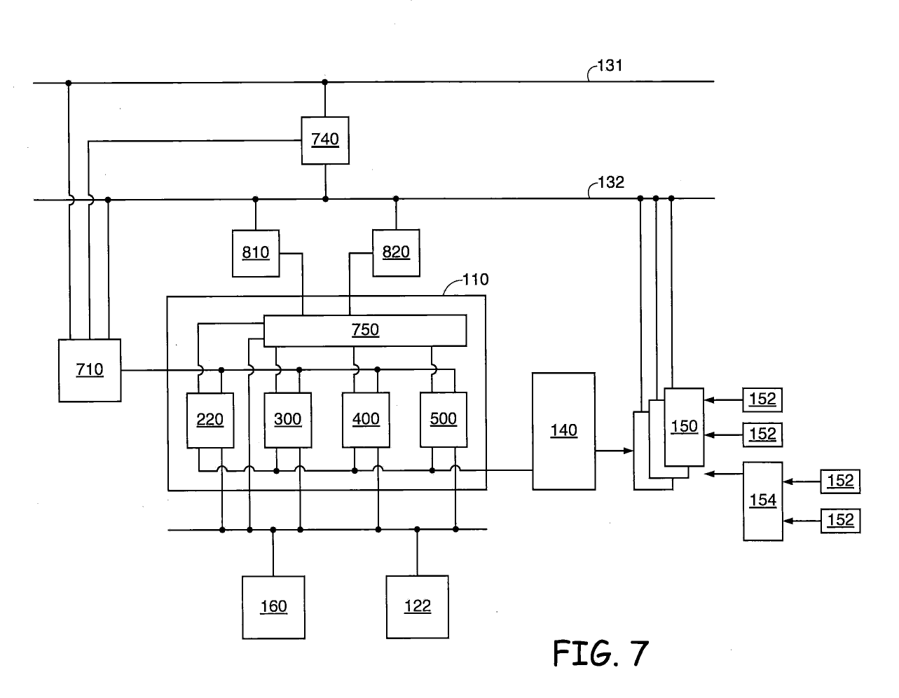

An additional feature of the PCM 110 is illustrated in FIG. 7. FIG. 7 is similar to the illustration of FIG. 2, except that in FIG. 7, the PCM 110 is also coupled to static devices such as capacitor banks 810 and/or inductor banks 820 that are present at the PV power plant and which can be selectively coupled to the collector bus 132. The capacitor and inductor banks 810, 820 are often present in a PV power plant in order to provide additional power resources that can be used to meet the set points received by the PCM 110. The PCM 110 is configured to directly control the use of the capacitor and inductor banks 810, 820, if present in the PV power plant, as described below.

In general, at a PV power plant, capacitor and inductor banks 810, 820 are used as slow-acting devices, meaning that the capacitor and inductor banks have slower response times than the more dynamically-responsive inverters controlled by the PV plant control module. The capacitor and inductor banks 810, 820 in a PV power plant are used to either extend the PV power plant's ability to provide reactive power or to preserve the dynamic control range of the PV power plant's inverters 150 and converters 154 for contingencies. In other words, by using the slow-acting static devices to provide a portion of the PV power plant's reactive power, a greater proportion of the PV power plant's inverters 150 and converters 154 may be available to act quickly to meet any sudden changes in power demands.

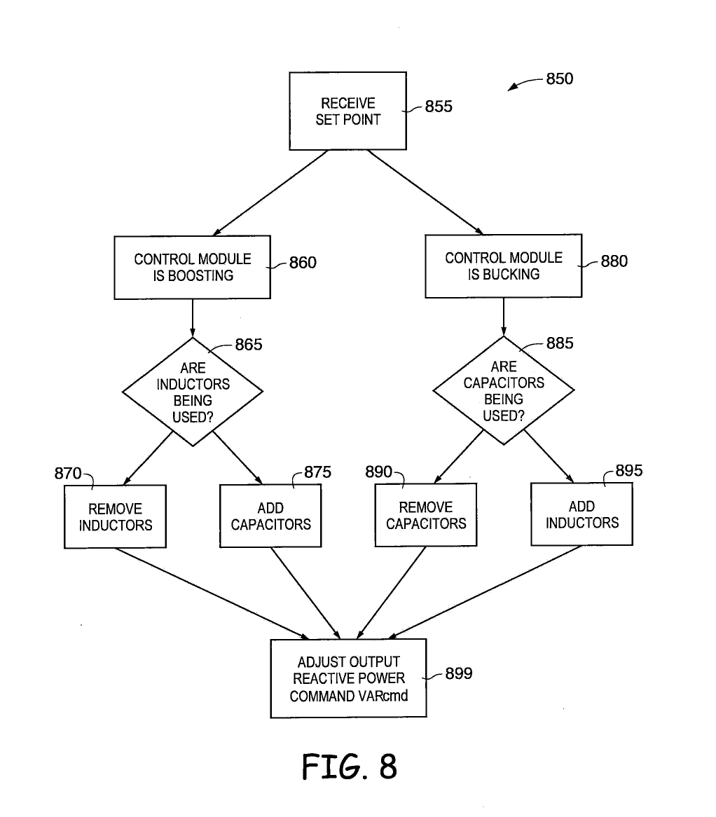

When the PCM 110 uses controllers 300 and 500 to monitor and respond to voltage and power factor set points, respectively, the PCM 110 can output commands that result in the PV plant control module 140 directing inverters 150 and converters 154 to meet the command set points. However, in response to changes in voltage and power factor set points, the PCM 110 may also issue commands to add or remove static devices such as capacitor and inductor banks 810, 820. This is illustrated in method 850 of FIG. 8.

In method 850, the PCM 110 receives a set point (step 855). If, as a result of a set point received at the PCM 110, an increase in reactive power is required, meaning that the PCM 110 is boosting (step 860), the PCM 110 can direct that either an inductor 820 be removed or a capacitor 810 be added. The PCM 110 checks to see that no inductors 820 are currently under its control (step 865). If one is, the inductor is removed (step 870). If there is not, a capacitor is added (step 875). Additional inductors 820 may be removed (if already under the control of the PCM 110) or additional capacitors 810 may be added.

If, as a result of a set point received at the PCM 110, a decrease in reactive power is required, meaning that the PCM 110 is bucking (step 880), the PCM 110 can direct that either a capacitor 810 be removed or an inductor 820 be added. The PCM 110 checks to see that no capacitors 810 are currently under its control (step 885). If one is, the capacitor is removed (step 890). If there is not, an inductor is added (step 895). Additional capacitors 810 may be removed (if already under the control of the PCM 110) or additional inductors 820 may be added.

Therefore, when the PCM 110 adds or removes a static device in response to a received set point, the PCM's own reactive power command VARcmd that is output is changed based on the compensation provided by the static devices. As is shown in step 899 of method 850, the output reactive power command VARcmd is changed by adding or subtracting a multiple of the step size (determined by the capacitors 810 or inductors 820), indicating the amount of reactive power added or subtracted by the addition or removal of static devices.

The above description relates to embodiments wherein the PCM 110 sends reactive power commands to a separate PV plant control module 140 that then controls the output of PV power plant inverters 150 and/or converters 154. Of course, variations such as combining the PCM 110 and PV plant control module 140 are also contemplated by the above description. Additionally, while the above description relates specifically to a PV power plant, the PCM 110 and PV plant control module 140 may be used with other types of power plants, including wind and geothermal power plants. Furthermore, the PCM 110 and PV plant control module 140 may be each implemented in either hardware or as software on a processor, or in a combination of hardware and software. As specific examples, the controllers 220, 300, 400, 500, the master control module 750, the PID controllers 330, 430 and 520, and PV plant control module 140 may each be implemented in hardware, software, or a combination thereof. The above description and drawings are only to be considered illustrative of specific embodiments, which achieve the features and advantages described herein. Modifications and substitutions to specific process conditions can be made. Accordingly, the embodiments of the invention are not considered as being limited by the foregoing description and drawings, but is only limited by the scope of the appended claims.

What is claimed as new and desired to be protected by Letters Patent of the United States is:

1. A control system for a power plant comprising one or more power sources, the control system comprising:
a point of interconnection coupling a power output of the power plant with a utility grid;
one or more measuring devices for measuring power output parameters associated with the point of interconnection or the power plant; and
a control module, comprising:
a plurality of first controller sections, each first controller section configured to receive measured parameters from the one or measuring devices, to compare the received measured parameters with corresponding set points, and to provide a reactive power command to at least one power regulator associated with said power plant; and
a master control section that selectively enables one of the first controller sections to output the reactive power command.

2. The system of claim 1, further comprising one or more second controller sections configured to receive measured parameters from the one or measuring devices, to compare the received measured parameters with corresponding maximum set points, and to provide an active power limit command to at least one power regulator associated with said power plant.

3. The system of claim 1, wherein the one or more first controller sections includes a plurality of at least one voltage controller, at least one reactive power controller, and at least one power factor controller.

4. The system of claim 3, wherein the voltage controller is comprised of a closed-loop feedback section and a droop voltage source that provides a signal that compensates for voltage droop in the power plant.

5. The system of claim 3, wherein the reactive power controller is comprised of a closed loop feedback section and a droop voltage source that provides a signal that compensates for voltage droop in the power plant.

6. The system of claim 3, wherein the power factor controller is comprised of a closed loop feedback section.

7. The system of claim 1, wherein the point of interconnection includes at least one transmission bus on a utility grid side of the point of interconnection and at least one collector bus on a power plant side of the point of interconnection, and wherein the system includes a voltage controller, a reactive power controller and a power factor controller for at least one of the transmission buses and collector buses at the point of interconnection.

8. The system of claim 1, wherein the master control section is configured to selectively enable one of the one or more first controller sections based on which controller section is receiving a parameter that differs from a received set point by greater than a predefined range.

9. The system of claim 8, wherein the controller section receiving a parameter that differs from a received set point by greater than a predefined range is configured to send a signal to the master control section when said predefined range is exceeded.

10. The system of claim 1, wherein the master control section is configured to selectively enable one of the one or more first controller sections based on a predefined controller priority.

11. The system of claim 1, further comprising a plurality of static devices coupled to the control module, wherein the static devices comprise at least one capacitor bank.

12. The system of claim 11, wherein the static devices further comprise at least one inductor bank.

13. The system of claim 12, wherein the control module is further configured to add or remove one or more of the static devices in response to one of the set points.

14. The system of claim 1, further comprising a power plant controller which receives the reactive power command from the enabled one of the controller sections and distributes the reactive power command to the at least one power regulator.

15. The system of claim 14, wherein the control module and the power plant controller are configured as a single module.

16. The system of claim 1, wherein the power plant is a photovoltaic power plant, and the power regulators are inverters.

17. A control system for a photovoltaic power plant comprising one or more power sources, the control system comprising:
a point of interconnection coupling a power output of the power plant with a utility grid; and
a control module, comprising:
a voltage controller configured to receive a voltage set point, to compare the received voltage set point with a measured voltage at the point of interconnection, and to provide a reactive power command to at least one power regulator associated with said power plant;
a reactive power controller configured to receive a reactive power set point, to compare the received reactive power set point with a measured reactive power at the point of interconnection, and to provide a reactive power command to at least one power regulator associated with said power plant;
a power factor controller configured to receive a power factor set point, to compare the received power factor set point with a measured power factor at the point of interconnection, and to provide a reactive power command to at least one power regulator associated with said power plant; and
a master control module that selectively enables one of the controllers to output the reactive power command.

18. The system of claim 17, wherein the voltage controller is comprised of a closed-loop feedback section and a droop voltage section that provides a signal that compensates for voltage droop in the power plant.

19. The system of claim 17, wherein the reactive power controller is comprised of a closed loop feedback section and a droop voltage section that provides a signal that compensates for voltage droop in the power plant.

20. The system of claim 17, wherein the power factor controller is comprised of a closed loop feedback section.

21. The system of claim 17, wherein the point of interconnection includes at least one transmission bus on a utility grid side of the point of interconnection and at least one collector bus on a power plant side of the point of interconnection, and wherein the system includes a voltage controller, a reactive power controller and a power factor controller for at least one of the transmission buses and collector buses at the point of interconnection.

22. The system of claim 17, wherein the master control module is configured to selectively enable one of the controllers based on which controller is receiving a parameter that differs from a received set point by greater than a predefined range.

23. The system of claim 22, wherein the controller receiving a parameter that differs from a received set point by greater than a predefined range is configured to send an alarm to the master control module when the predefined range is exceeded.

24. The system of claim 17, wherein the master control module is configured to selectively enable one of the controllers based on a predefined controller module priority.

25. The system of claim 17, further comprising a plurality of static devices coupled to the control module, wherein the static devices comprise at least one capacitor bank

26. The system of claim 25, wherein the static devices further comprise at least one inductor bank.

27. The system of claim 26, wherein the control module is further configured to add or remove one or more of the static devices in response to one of the set points.

28. The system of claim 17, further comprising a power plant controller which receives the reactive power command from the enabled one of the controllers and distributes the reactive power command to the power regulators.

29. The system of claim 28, wherein the control module and the power plant controller are configured as a single module.

30. A method of controlling a power plant using a control module, the method comprising:
receiving one or more set points defining a desired power parameter setting;
receiving one or more measured parameters representing power characteristics at a point of interconnection between the power plant and a utility grid;
comparing the one or more set points with corresponding measured parameters to determine if one or more reactive power output commands are to be issued to the power plant;
enabling a controller to output one of the determined one or more reactive power output commands to the power plant.

31. The method of claim 30, wherein the received set points include at least one of a voltage set point, a reactive power set point, and a power factor set point.

32. The method of claim 30, wherein the point of interconnection includes at least one transmission bus on a utility side of the point of interconnection and at least one collector bus on a power plant side of the point of interconnection, and wherein the received set points include set points for desired power parameter settings on either the at least one transmission bus or the at least one collector bus.

33. The method of claim 30, wherein the received measured parameters include at least one of a voltage, a reactive power, and a power factor.

34. The method of claim 30, wherein the point of interconnection includes at least one transmission bus on a utility side of the point of interconnection and at least one collector bus on a power plant side of the point of interconnection, and wherein the received measured parameters include measured parameters for either the at least one transmission bus or the at least one collector bus.

35. The method of claim 30, wherein the comparison is at least one of a voltage comparison, a reactive power comparison, and a power factor comparison.

36. The method of claim 30, wherein the enabling further comprises switching the output reactive power output command from a first reactive power output command to a second reactive power output command when one of the measured parameters exceeds a predefined range bounding a set point associated with the measured parameter.

37. The method of claim 36, further comprising switching back to the first reactive power output command when the one of the measure parameters is within the predefined range bounding the set point associated with the measured parameter.

38. The method of claim 37, wherein switching back to the first reactive power output command is subject to a predefined minimum time limit.

39. The method of claim 30, wherein the enabling further comprises determining if conflicting set points have been received, and, if so, outputting the output reactive power output command that corresponds to the set point with a highest priority.

40. The method of claim 30, further comprising adding and removing capacitors to a reactive power generating capability of the power plant.

41. The method of claim 30, further comprising adding and removing inductors to a reactive power generating capability of the power plant.

42. The method of claim 30, further comprising using one or more static devices to influence the amount of reactive power commanded by the output reactive power output command, wherein the static devices include capacitors and inductors.

43. The method of claim 42, wherein using one or more static devices comprises determining if a change in reactive power is required by the power plant.

44. The method of claim 43, wherein if an increase in reactive power is required, determining if any inductors are being used by the power plant to affect the reactive power generating capability of the power plant.

45. The method of claim 44, wherein if one or more inductors are being used, removing at least one inductor from contributing to the reactive power generating capability of the power plant.

46. The method of claim 44, wherein if one or more inductors are not being used, adding at least one capacitor to contribute to the reactive power generating capability of the power plant.

47. The method of claim 43, wherein if a decrease in reactive power is required, determining if any capacitors are being used by the power plant to affect the reactive power generating capability of the power plant.

48. The method of claim 47, wherein if one or more capacitors are being used, removing at least one capacitor from contributing to the reactive power generating capability of the power plant.

49. The method of claim 47, wherein if one or more capacitors are not being used, adding at least one inductor to contribute to the reactive power generating capability of the power plant.
